(19) United States
(12) Patent Application Publication
(10) Pub. No.: US 2026/0118906 A1
(43) Pub. Date: Apr. 30, 2026

(54) SEQUENCE CONTROLLER, INSTRUMENTATION SYSTEM, AND SEQUENCE CONTROL METHOD

(71) Applicant: Hitachi, Ltd., Tokyo (JP)

(72) Inventors: Takanobu TSUNODA, Tokyo (JP); Tomonori SEKIGUCHI, Tokyo (JP)

(21) Appl. No.: 19/273,634

(22) Filed: Jul. 18, 2025

(30) Foreign Application Priority Data
Oct. 28, 2024 (JP) 2024-189244

(51) Int. Cl. G06F 1/14

(52) U.S. Cl. CPC G06F 1/14

(57) ABSTRACT

An instrumentation system includes a first instrumentation device, a second instrumentation device, a third instrumentation device, a sequence controller, and a control target device, outputs main time information having a first time resolution on the basis of a first clock signal by a high accuracy time measurement unit of the sequence controller, outputs sub-time information having a second time resolution higher than the first time resolution on the basis of each timing of a second clock signal different from the first clock signal and a reference signal outputted by the first time measurement device, and outputs a trigger signal instructing an operation timing to each of the instrumentation devices on the basis of the main time information and the sub-time information by a sequence control unit.

### CROSS-REFERENCE TO RELATED APPLICATION

The present application claims priority from Japanese application JP2024-189244, filed on October 28, 2024, the content of which is hereby incorporated by reference into this application.

### BACKGROUND

The present invention relates to, for example, a sequence controller, an instrumentation system, and a sequence control method.

It is regarded as being certain that in the near future, there will come a limit to improvement in performance by the miniaturization of semiconductor devices having supported the advancement of computers over more than half a century from the contrast between the process rule and the interatomic distance of silicon.

For that, a quantum computer is an attempt to overcome the limit by a new calculation principle and device, and as its technique, a quantum computation device and computation method using a superconducting circuit, an ion trap, a photon, a silicon quantum dot, and the like are proposed.

At the present time, assuming the social implementation of the quantum computer in the near future, the proof of the principle of a system called an NISQ (Noisy Intermediate-Scale Quantum device) in which the number of quantum bits is relatively small and is approximately 100 to 1000 has been advanced. Further, the search for an error correction algorithm that is necessary for implementing a fault-tolerant quantum computer (FTQC) following the NISQ, and the development of a control technique that becomes its achieving means have been advanced in parallel.

Then, to achieve the quantum computer to which the quantum computation device having, as the computation principle, a quantum effect exhibited at extremely low temperature like the single electron spin in the silicon quantum dot is applied, a dilution refrigerator is usually selected as a device into which the quantum computer is incorporated.

In this case, the quantum computation device is thermally contacted with and fixed to a mixing chamber having the lowest temperature in the dilution refrigerator. To limit the power consumption by the device arranged in the dilution refrigerator to be equal to or less than the value based on the cooling ability, adopted is a configuration like an experiment device in which a control signal necessary for controlling the operation of the quantum computation device is applied from a signal generator arranged outside the dilution refrigerator, and a computation result (quantum dot state) is read from a measurement device outside the dilution refrigerator.

### SUMMARY

The quantum computer with the quantum computation device as the core is actually an analog computer in which analog information is given to the quantum dot. Typically, in the classic computer that is deterministically operated in synchronization with the clock signal, the computation result is not changed according to the frequency of the clock signal. On the other hand, in the quantum computer, the accuracy of the control signal waveform decides the computation accuracy, that is, the fidelity of the quantum operation.

For that, in implementing the system, it is necessary to combine a bias voltage generator and a high frequency generator including necessary and sufficient output accuracy and characteristic, and an instrumentation device such as a minute voltage/current amplification device used for reading the quantum dot state. Then, in order that the order of the operation of each instrumentation device is controlled to be suitable to the control sequence of the quantum operation to be executed, and that the relative operation timings between the instrumentation devices are brought into coincidence (or are brought into synchronization) with each other with a high time accuracy (for example, 10 nanoseconds), a hardware mechanism is desirably required to be included.

In addition to the above, in the FTQC, the controls in the respective viewpoints of the computation operation and the system management cannot be clearly separated. That is, in addition to the original quantum operation to be executed by the user, the syndrome measurement for identifying the content of the error of the quantum bit, and the process corresponding to the predetermined error correction operation based on the content of the detected error are mixed in the single control sequence. With this, a complicated and long and large control waveform including a wide time scale and a high resolution is required to be generated.

In addition, it is also necessary to consider a process by which according to the material and the configuration of the quantum computation device, the variation in the quantum dot characteristic caused in the time scale different from the sequence control and its change with time are measured, and the control waveform is dynamically or statically calibrated.

Japanese Unexamined Patent Application Publication No. 2009-181576 discloses a technique in which in an information processor on which a particular microprocessor is mounted, an absolute time expression having a high resolution and a shared format is efficiently calculated on the basis of the instruction values of an incorporated time stamp counter (TSC) counting the number of clocks inputted after the reset of the microprocessor and a real time clock (RTC) further included in the information processor.

For example, the case where communication is performed between a plurality of information processors each having the independent TSC is preferable for an application that is worth adding time information. On the other hand, it is fundamentally impossible to handle an interval time shorter than a time required for calculating time stamp information.

Accordingly, an object of the present invention is to provide a sequence controller, an instrumentation system, and a sequence control method in which assuming application to sequence control in a quantum computer in which a computation process and system management are inseparable, a wide time scale is simply handled with a high accuracy.

In addition, as one of the limits specific to the quantum computer that the classic computer does not have, a point in which there is an upper limit to a time that can maintain the quantum state of the quantum dot is given. In particular, in the FTQC in which a large number of quantum dots are additionally implemented for the error correction, and a large number of times of quantum operations targeting them are required, securing the scalability with respect to the number of quantum dots is also an important viewpoint.

Accordingly, to prevent the transfer bandwidth of measurement data related to the error correction from rate-limiting the computation performance of the system, the introduction of a computation algorithm that achieves the error correction by non-real time postprocessing has been studied. As a means that efficiently manages the order relationship between various measurement data in large amount and secures the traceability of the system operation, absolute time information having a high accuracy is expected to be given.

A sequence controller as one aspect of the present invention is a sequence controller that is connected to one or more instrumentation devices. The sequence controller includes a first time measurement device outputting main time information having a first time resolution on the basis of a first clock signal, a second time measurement device outputting sub-time information having a second time resolution higher than the first time resolution on the basis of each timing of a second clock signal different from the first clock signal and a reference signal outputted by the first time measurement device, and a sequence control unit generating and outputting a trigger signal instructing an operation timing to each of the one or more instrumentation devices on the basis of the main time information and the sub-time information.

In addition, an instrumentation system as another aspect of the present invention is an instrumentation system. The instrumentation system includes one or more instrumentation devices, a first time measurement device outputting main time information having a first time resolution on the basis of a first clock signal, a second time measurement device outputting sub-time information having a second time resolution higher than the first time resolution on the basis of each timing of a second clock signal different from the first clock signal and a reference signal outputted by the first time measurement device, and a sequence control unit generating and outputting a trigger signal instructing an operation timing to each of the one or more instrumentation devices on the basis of the main time information and the sub-time information.

In addition, an instrumentation system as a further aspect of the present invention is an instrumentation system that has one or more instrumentation devices. At least one of the one or more instrumentation devices includes a first time measurement device outputting main time information having a first time resolution on the basis of a first clock signal, a second time measurement device outputting sub-time information having a second time resolution higher than the first time resolution on the basis of each timing of a second clock signal different from the first clock signal and a reference signal outputted by the first time measurement device, a measurement unit measuring a control signal based on the main time information and the sub-time information to output measurement data, and a data accumulation unit storing data in a predetermined form in which the main time information, the sub-time information, and the measurement data are associated with each other.

Further, a sequence control method as a still another aspect of the present invention is a sequence control method of an instrumentation system. In accordance with a request from each of one or more time measurement devices, a trigger signal is generated with respect to the each time measurement device making the request according to a previously prepared sequence operation order by using main time information and sub-time information made to have a higher resolution than the main time information, and the generated respective trigger signals are synchronized with each other to sequence control the respective time measurement devices.

As one effect of the present invention, when the sequence control having a high accuracy like the quantum computer is required, the sequence control and the measurement data management that can cope with both of the wide time scale and the high resolution while being synchronized with the absolute time are enabled.

### BRIEF DESCRIPTION OF THE DRAWINGS

FIG. 1 is a block diagram illustrating the configuration of an instrumentation system according to a first embodiment;

FIG. 2 is a block diagram illustrating the configuration of a sequence controller according to the first embodiment;

FIG. 3 is a block diagram illustrating the configuration of a sequence control unit according to the first embodiment;

FIG. 4 is a table diagram illustrating the setting format of a control sequence table according to the first embodiment;

FIG. 5 is a block diagram illustrating the configuration of a first instrumentation device according to the first embodiment;

FIG. 6 is a block diagram illustrating the configuration of a second instrumentation device according to the first embodiment;

FIG. 7 is a block diagram illustrating the configuration of a third instrumentation device according to the first embodiment;

FIG. 8 is a flowchart illustrating the operation of a table read control unit according to the first embodiment;

FIG. 9 is a timing chart explaining main sequence control according to the first embodiment;

FIG. 10 is a timing chart of the sequence control in the instrumentation system;

FIG. 11 is a block diagram illustrating the configuration of an instrumentation system according to a second embodiment;

FIG. 12 is a block diagram illustrating the configuration of a sequence controller according to the second embodiment;

FIG. 13 is a block diagram illustrating the configuration of an instrumentation system according to a third embodiment;

FIG. 14 is a block diagram illustrating the configuration of a sequence controller according to the third embodiment;

FIG. 15 is a block diagram illustrating the configuration of a third instrumentation device according to the third embodiment; and

FIG. 16 is a configuration diagram illustrating the hardware configuration example of the sequence controller shared between the respective embodiments.

### DETAILED DESCRIPTION

Hereinbelow, the present embodiments will be described with reference to the accompanying drawings. In the accompanying drawings, the elements that are the same in function may also be denoted by the same numbers or the corresponding numbers. It should be noted that the accompanying drawings illustrate the embodiments and the examples in accordance with the principle of the present disclosure, and these are for understanding the present disclosure, and are never used to restrictively interpret the present disclosure. The description of the present specification is made only by way of typical example, and does not limit the scope of claims or the application examples of the present disclosure in any sense.

In the present embodiments, their description is made in sufficient detail in order for those skilled in the art to perform the present disclosure, but other implementations and forms are also enabled, and it is necessary to understand that the change in structure and configuration and various element replacements are enabled without departing from the scope and the spirit of the technical idea of the present disclosure. Therefore, the following description should not be construed by being limited thereto.

In the configurations of the examples described below, the same reference numerals are used by being shared between the different drawings for the same portions or the portions having similar functions, and the overlapped description thereof may be omitted.

When there are a plurality of elements having the same or similar function, different subscripts may be given to the same reference numerals for description. However, when the plurality of elements are not required to be discriminated, the subscripts may be omitted for description.

The denotations of the “first”, “second”, “third”, and the like in the present specification and the like are given for identifying the components, and do not necessarily limit the number, the order, or the contents thereof. In addition, the number for identifying each component is used for each context, and the number used in one context does not necessarily represent the same configuration in other contexts. In addition, the component identified by a certain number is not inhibited from serving as the functions of the components identified by other numbers.

To easily understand the invention, the position, size, shape, range, and the like of each configuration illustrated in the drawings and the like may not represent the actual position, size, shape, range, and the like. For this, the present invention is not necessarily limited to the position, size, shape, range, and the like disclosed in the drawings and the like.

The publications, the patents, and the patent applications cited in the present specification configure part of the description of the present specification as-is.

Unless otherwise specified in the contexts, the component represented in the singular in the present specification includes the plural.

In the examples, regarding an instrumentation system like a quantum computer configured by combining a plurality of instrumentation devices, a configuration providing the instrumentation system including a method for generating an absolute time having a predetermined time resolution, and a sequence controller outputting a trigger signal to each instrumentation device on the basis of the absolute time will be described.

An instrumentation system as one example of the examples includes a first time measurement device outputting main time information having a first time resolution, and a second time measurement device outputting sub-time information having a second time resolution higher than the first time resolution and initialized in synchronization with a reference signal outputted by the first time measurement device, and further includes a sequence controller generating a trigger signal instructing an operation timing to each of the one or more instrumentation devices on the basis of the main time information and the sub-time information.

According to the absolute time generation method and the sequence controller according to the examples, the respective instrumentation devices can be synchronously operated with a high accuracy on the basis of the absolute time, and the measurement data can be managed by being associated with the time information, thereby achieving the instrumentation system that is highly practical.

### Example 1

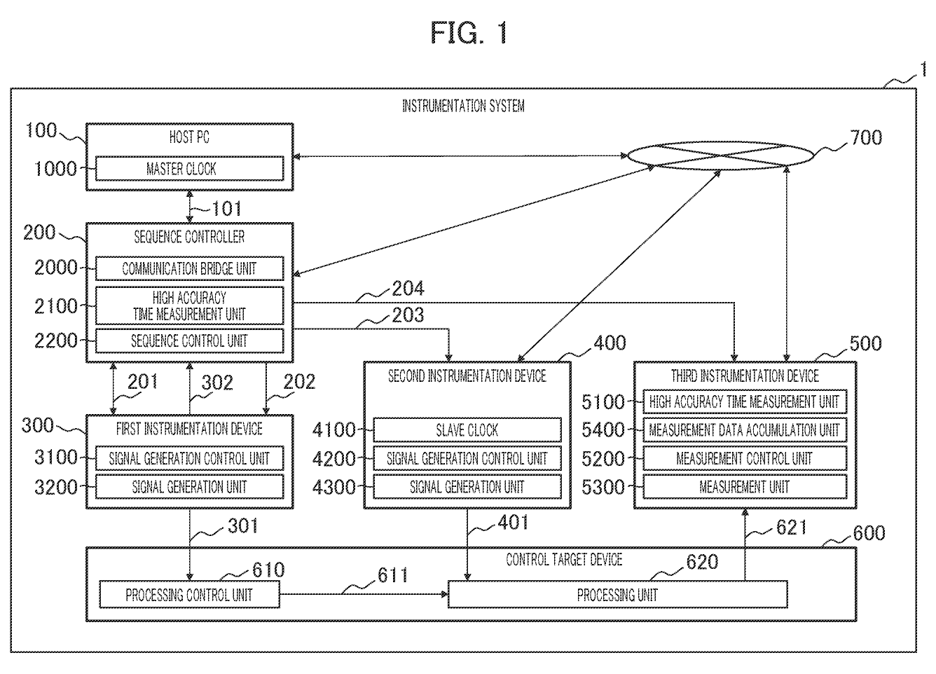

FIG. 1 illustrates the configuration of an instrumentation system 1 according to a first embodiment. The instrumentation system 1 of the present embodiment is systematized by combining a control target device 600 that is a subject executing a computation process intended by the instrumentation system 1, a host PC 100 setting and managing this system, a first instrumentation device 300, a second instrumentation device 400, and a third instrumentation device 500 (an example of a plurality of instrumentation devices) each executing at least a portion of the control sequence of the computation, and a sequence controller 200 outputting an inherent synchronization control signal to each of at least portions of the first instrumentation device 300, the second instrumentation device 400, and the third instrumentation device 500 on the basis of a control sequence table set by the host PC 100.

The host PC 100, the sequence controller 200, the second instrumentation device 400, and the third instrumentation device 500 are desirably mutually connected by a time synchronization communication network 700 supporting a known time synchronization protocol such as the IEEE1588.

With this, the absolute time indicated by the incorporated clock of each device configuring the instrumentation system 1 is synchronized with an accuracy of, for example, an approximately 1 microsecond, on the basis of the incorporated clock of the host PC 100.

It should be noted that the incorporated clock as the basis for the time synchronization is called a master clock 1000, and the incorporated clock of the device other than that is called a slave clock. The master clock 1000 may be the incorporated clock of the device other than the host PC 100, and may be a dedicated device (not illustrated) providing the time information into the instrumentation system 1 via the time synchronization communication network 700.

In the case of the latter, the time information having a higher accuracy can be acquired on the basis of a navigation signal received from a navigation satellite configuring a global navigation satellite system (GNSS).

The host PC 100 is a typical information processor including, in addition to the master clock 1000 described above, a microprocessor, a memory, a storage device, an input device, an output device, and the like, not illustrated.

In the host PC 100, a system control application performing the state monitoring and the operation management of the instrumentation system 1 is operated, and includes at least a system setting function performing device-inherent setting with respect to the sequence controller 200, the first instrumentation device 300, the second instrumentation device 400, and the third instrumentation device 500, and an access function with respect to the measurement data in each device.

The system control application interprets the control sequence of the computation process designated as an execution target by the user, and performs predetermined communication in which, for example, device-inherent setting information necessary for the computation process is supplied via a communication section 101 to the sequence controller 200 and the first instrumentation device 300, and the device-inherent setting information necessary for the computation process is supplied via the time synchronization communication network 700 to the second instrumentation device 400 and the third instrumentation device 500, or the measurement data acquired by the instrumentation device is transferred to the host PC 100.

Here, the communication section 101 may be an interface based on a standard communication specification, such as the USB (trademark), the SPI (trademark), the I2C (trademark), the RS-232C, the GP-IB, the PCI Express (trademark), and the Ethernet (trademark), and may have its own specification based on a general-purpose input/output port.

It should be noted that for the communication between the host PC 100 and the sequence controller 200, the time synchronization communication network 700 may be used in place of the communication section 101. Further, the communication between the host PC 100 and the second instrumentation device 400 or the third instrumentation device 500 may be performed via communication section (not illustrated) different from the time synchronization communication network 700.

The sequence controller 200 includes a high accuracy time measurement unit 2100 providing the absolute time information having an improved resolution in conjunction with the time synchronization communication network 700.

A sequence control unit 2200 independently generates and outputs trigger signals 202, 203, 204 instructing operation timings to the first instrumentation device 300, the second instrumentation device 400, and the third instrumentation device 500 in accordance with the absolute time information outputted by the high accuracy time measurement unit 2100 and an instrumentation device operation state 302 outputted by the first instrumentation device 300 while referring to the setting information (the control sequence table described later) previously transferred via the communication section 101 from the host PC 100.

A communication bridge unit 2000 provides a communication section 201 relaying the communication between the host PC 100 and the first instrumentation device 300 to become an interface to the first instrumentation device 300. The details of the configuration and the operation will be described later together with other drawings.

The first instrumentation device 300 does not incorporate the function providing the time information, and its operation timing depends on the sequence controller 200.

When the operation timing is instructed via the trigger signal 202, a signal generation control unit 3100 instructs a signal generation unit 3200 to switch the output state such that the output of a control output signal 301 is brought into a state of being designated as a portion of the setting information, on the basis of the setting information previously transferred via the communication section 201 from the host PC 100, and notifies that the switching operation is being executed, to the sequence controller 200 by the instrumentation device operation state 302 as a signal.

When the switching is completed, the signal generation unit 3200 notifies that by the instrumentation device operation state 302. The details of the configuration and the operation will be described later together with other drawings.

Although not particularly limited, the setting information may include the output value of the control output signal 301, and an output delay time from the reception of the operation timing instruction to the changing of the output value.

In addition, the setting information that can be held at the same time by the signal generation control unit 3100 may be a plurality of sets of output values and output delay times, and the signal generation unit 3200 should include an operation mode processing only one piece of setting information for each trigger signal 202, and an operation mode continuously processing a plurality of pieces of setting information designated by a predetermined means such as a termination flag.

To improve the flexibility of the control in the operation mode of the latter, an output holding time corresponding to a waiting time after the output value is changed should be added to the setting information.

The second instrumentation device 400 incorporates the slave clock in which the synchronization state is maintained between the second instrumentation device 400 and the master clock 1000 by the time synchronization communication network 700.

When detecting that the time information indicated by the slave clock coincides with or passes an execution start time as a portion of the setting information previously transferred via the time synchronization communication network 700 (or its alternative communication section, not illustrated) from the host PC 100, or when the operation timing is instructed via the trigger signal 203 from the sequence controller 200, a signal generation control unit 4200 instructs a signal generation unit 4300 to switch the output state such that the output of a control output signal 401 is brought into a state of being designated as a portion of the setting information. The details of the configuration and the operation will be described later together with other drawings.

Although not particularly limited, the setting information may include the output value of the control output signal 401, and one of the execution start time and the output delay time from the reception of the operation timing instruction to the changing of the output value. In addition, the setting information that can be held at the same time by the signal generation control unit may include a plurality of sets of setting information.

In the present embodiment, as the operation start condition of the second instrumentation device 400, the time information indicated by a slave clock 4100 incorporated in the device and the trigger signal 203 respectively having different time resolutions can be selected. The time information indicated by the slave clock 4100 incorporated in the device typically has a resolution of 1 second, and when the trigger signal 203 is used, it is practical to have a resolution of approximately 1 to 10 nanoseconds, although depending on the design.

The third instrumentation device 500 includes a high accuracy time measurement unit 5100 similar to the sequence controller 200. When detecting that the time information indicated by the high accuracy time measurement unit 5100 coincides with or passes the execution start time as a portion of the setting information previously transferred via the time synchronization communication network 700 (or its alternative communication section, not illustrated) from the host PC 100, or when the operation timing is instructed via the trigger signal 204 from the sequence controller 200, a measurement control unit 5200 instructs a measurement unit 5300 to measure a result signal 621 outputted by the control target device 600 on the basis of the setting information.

The measurement data generated by the measurement unit 5300 is stored in a measurement data accumulation unit 5400 together with the time information. The details of the configuration and the operation will be described later together with other drawings.

Although not particularly limited, the setting information may include various parameters as the measurement conditions, and one of the execution start time and the measurement delay time from the reception of the operation timing instruction to the execution of the measurement operation. In addition, the setting information that can be held at the same time by the measurement control unit 5200 may include a plurality of sets of setting information.

In the present embodiment, as the operation start condition of the third instrumentation device 500, one of the time information indicated by the high accuracy time measurement unit 5100 incorporated in the device and the trigger signal 204 can be selected, but both have the same time resolution. For that, only the former is implemented in the case of the instrumentation device incorporating the high accuracy time measurement unit 5100, and only the latter is implemented in the case of the instrumentation device not incorporating the high accuracy time measurement unit 5100, thereby causing no problem in practical use.

The control target device 600 includes a processing control unit 610, and a processing unit 620. The processing control unit 610 converts, to an internal signal 611, the operation definition information defining the operation of the device acquired from the control output signal 301. The processing unit 620 receives, as an input, the control output signal 401, executes predetermined processing in accordance with the internal signal 611, and outputs the processing result to the result signal 621.

It should be noted that the control output signal 301, the control output signal 401, and the result signal 621 may include a plurality of control output signals 301, a plurality of control output signals 401, and a plurality of result signals 621, respectively, and each signal may have either an analog value or a digital value.

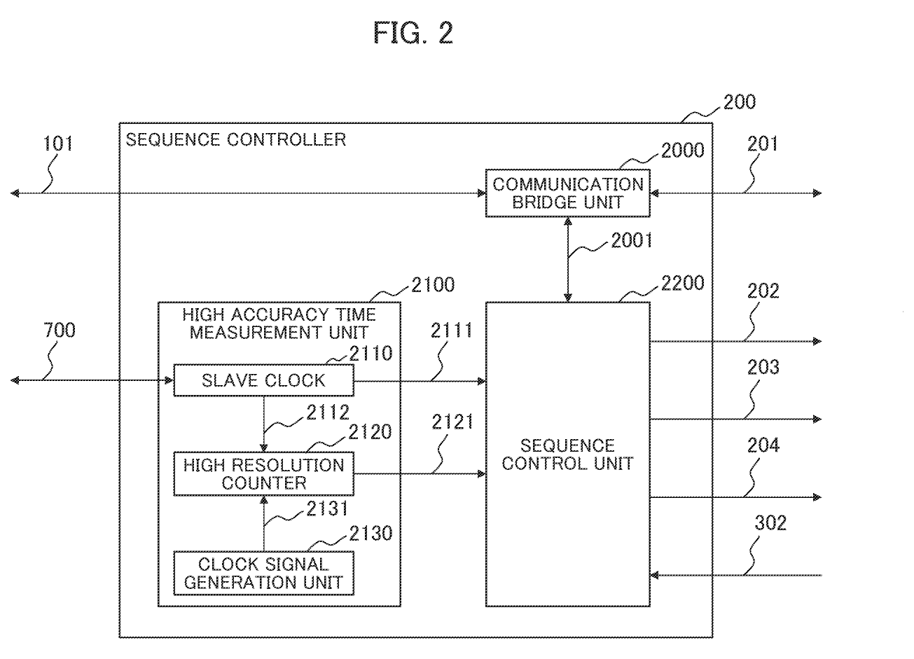

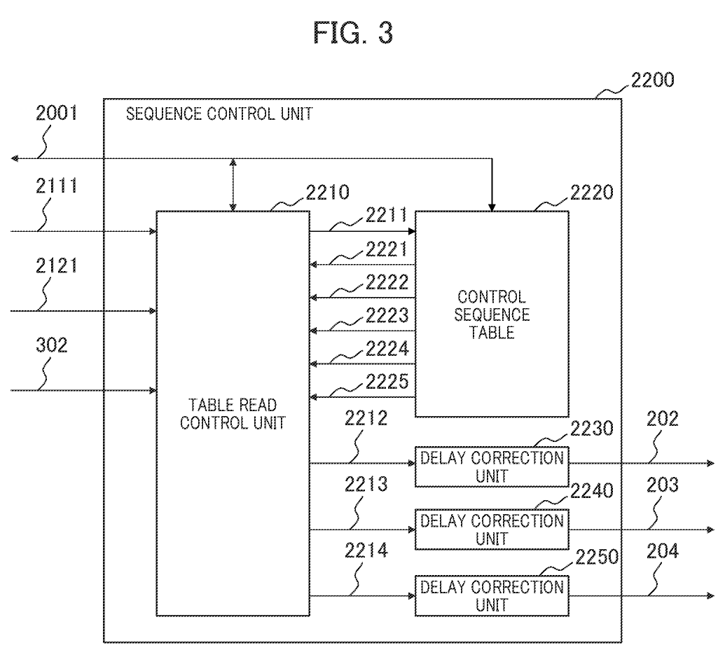

Next, the sequence controller 200 will be described with reference to FIG. 2. FIG. 2 is a block diagram illustrating the detailed configuration of the sequence controller 200. The controller 200 includes the communication bridge unit 2000, the sequence control unit 2200, and the high accuracy time measurement unit 2100 including a slave clock 2110 (first time measurement device), a high resolution counter 2120 (first time measurement device), and a clock signal generation unit 2130. The detailed configuration of the sequence control unit 2200 among these will be described later with reference to FIG. 3.

The communication bridge unit 2000 controls the communication between the communication bridge unit 2000 and the host PC 100 connected by the communication section 101, and mutually converts various control signals for each communication between the communication bridge unit 2000 and an internal communication section 2001 in the case where the communication destination or the communication source is the sequence control unit 2200, and between the communication bridge unit 2000 and the communication section 201 in the case where the communication destination or the communication source is the first instrumentation device 300.

The configuration and the operation of the high accuracy time measurement unit 2100 are as follows. The synchronization state between the slave clock 2110 and the master clock 1000 is maintained by the time synchronization communication network 700, and the slave clock 2110 typically outputs each of main time information 2111 as the absolute time with a coarse granularity having a resolution of 1 second and a reference signal 2112 indicating the change point of the main time information.

The clock signal generation unit 2130 outputs a clock signal 2131 having a high accuracy and counting the high resolution counter 2120. However, the design value of the clock frequency is equal to or less than the inverse number of the minimum time resolution necessary for the sequence control (typically, 100 MHz to 1 GHz).

The high resolution counter 2120 is a counter initialized by the reference signal 2112 and incremented in synchronization with the clock signal 2131, and outputs sub-time information 2121.

The sub-time information 2121 corresponds to an element (that is, less than seconds) not expressed by the resolution of the main time information 2111 of the absolute time, so that the sub-time information 2121 is combined with the main time information 2111 to be able to express the absolute time having a high resolution without the additional time conversion process.

Although not particularly limited, to guarantee that the changing of the sub-time information 2121 is not later than the changing of the actual absolute time, the instrumentation system implementation should be regulated so as to have a characteristic in which the frequency deviation of the clock signal 2131 is not zero on the positive side, and is zero on the negative side.

In addition, although not particularly limited, the content of the high resolution counter 2120 may be modified so as to be initialized only at the change point at which the digit numbers in second in the main time information 2111 are changed from 59 to 00 and the subsequent change point for each set of N-time (provided that N is the divisor of 60) reference signal receptions. With this, the state where the content of the high resolution counter 2120 is not discontinuously changed can be maintained for N seconds.

Since the high resolution counter 2120 is only required to be able to hold only the information of less than seconds, the hardware scale and the power consumption can be saved. In addition, only the high resolution counter 2120 can manage the elapsed time based on the particular time, but like the TSC of Japanese Unexamined Patent Application Publication No. 2009-181576, the elapsed time based on the particular time is not associated with the absolute time.

The point in which the slave clock 2110 and the high resolution counter 2120 operated by the respective different clocks are hardware synchronized with each other by the initialization by the reference signal 2112 is the fundamental value of the present embodiment.

The sequence control unit 2200 incorporates the control sequence table that can be accessed via the internal communication section 2001 from the host PC 100. The sequence control unit 2200 outputs the trigger signals 202, 203, 204 instructing the operation timings to the first instrumentation device 300, the second instrumentation device 400, and the third instrumentation device 500, respectively, in accordance with the absolute time having a high resolution indicated by the main time information 2111 and the sub-time information 2121 and the operation state of the first instrumentation device 300 indicated by the instrumentation device operation state 302.

Next, the sequence control unit 2200 will be described with reference to FIG. 3. FIG. 3 is a block diagram illustrating the detailed configuration of the sequence control unit 2200. The control unit 2200 includes a table read control unit 2210, a control sequence table 2220 corresponding to the time table of the processing operation achieved by the linking of the respective instrumentation devices, and delay correction units 2230, 2240, 2250 outputting the trigger signals 202, 203, 204, respectively.

The table read control unit 2210 includes a read pointer (not illustrated) indicating the read position of the control sequence table 2220 that can be accessed via the internal communication section 2001 from the host PC 100, and outputs the content of the read pointer to a read entry 2211.

The control sequence table 2220 is a table storing the control information of a command corresponding to each step configuring the control sequence, and outputs, as the control information of the command to be executed next, stored in the entry designated by the read entry 2211, each of a command start condition 2221, a sequence termination flag 2222, a trigger signal 202 output request 2223, a trigger signal 203 output request 2224, and a trigger signal 204 output request 2225.

Further, on the basis of the contents of the command start condition 2221, the main time information 2111, the sub-time information 2121, and the instrumentation device operation state 302, the table read control unit 2210 evaluates, at all times, whether or not the execution of the command to be executed next should be started.

When evaluating that the command to be executed next is at the execution start timing, the table read control unit 2210 outputs the presence or absence of the output requests respectively indicated by the trigger signal 202 output request 2223, the trigger signal 203 output request 2224, and the trigger signal 204 output request 2225, as the respective trigger signal output request signals 2212, 2213, 2214, to the respective delay correction units 2230, 2240, 2250 as-is.

The delay correction units 2230, 2240, 2250 that receive the trigger signal output requests from the trigger signal output request signals 2212, 2213, 2214, respectively, delay the request signals by the fixing times that are independent from each other, and then, output, as the respective trigger signals 202, 203, 204, to the first instrumentation device 300, the second instrumentation device 400, and the third instrumentation device 500, respectively. The detailed flow and timing chart related to the sequence control will be described later with other drawings.

Here, the delay time set to each of the delay correction units 2230, 2240, 2250 is decided by the following reference in consideration of the propagation delay time of the trigger signal. That is, by the experimental method or the estimation and the like from the wiring length, the propagation delay time of each of the trigger signals 202, 203, 204 is decided, and regarding each of the trigger signals, the delay time in which the sum of the propagation delay time and the delay time is constant and has a sufficiently small value is selected, and is set to each of the delay correction units.

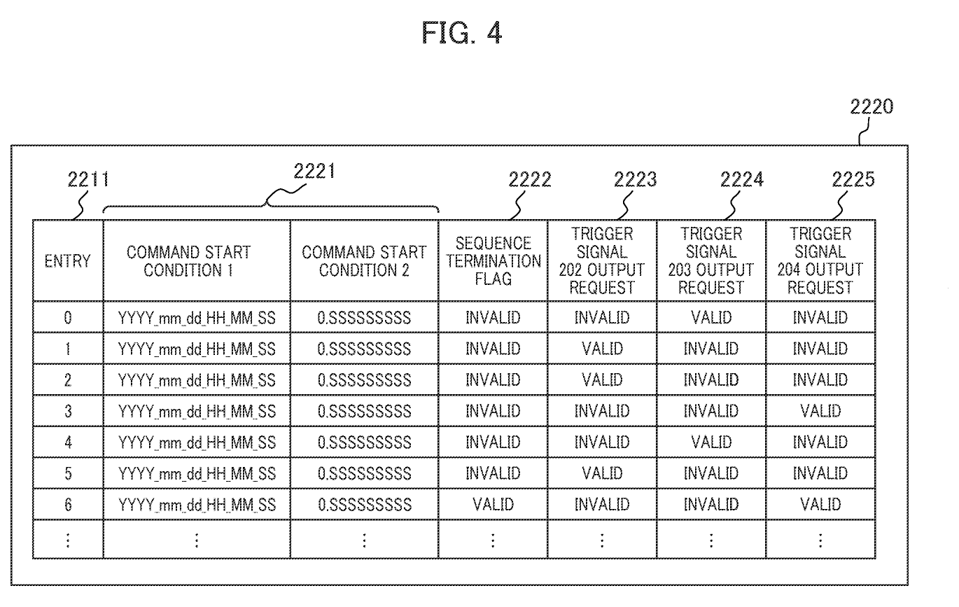

Next, the control sequence table 2220 will be described with reference to FIG. 4. FIG. 4 illustrates the setting format of the control sequence table 2220. The control sequence table 2220 includes a plurality of entries. Each entry identified by the read entry 2211 holds the following control information regarding the command corresponding to 1 step configuring the control sequence.

The command start condition 2221: The absolute time to start the execution of the command (the condition 1 is the main time information, and the condition 2 is the sub-time information) is designated. The setting value of this field is outputted, as the command start condition 2221, to the table read control unit 2210.

The sequence termination flag 2222: When this field is set to “valid”, the command is the final command of the control sequence that is being executed, and the command of the subsequent entry, that is, the next entry, is not executed. When the setting is “invalid”, the command of the next entry is executed. The setting value of this field is outputted, as the sequence termination flag 2222, to the table read control unit 2210.

The trigger signal 202 output request 2223: When this field is set to “valid”, this indicates that the execution is requested via the trigger signal 202 to the first instrumentation device 300 that is the execution subject of the command. The setting value of this field is outputted, as the trigger signal 202 output request 2223, to the table read control unit 2210.

The trigger signal 203 output request 2224: When this field is set to “valid”, this indicates that the execution is requested via the trigger signal 203 to the second instrumentation device 400 that is the execution subject of the command. The setting value of this field is outputted, as the trigger signal 203 output request 2224, to the table read control unit 2210.

The trigger signal 204 output request 2225: When this field is set to “valid”, this indicates that the execution is requested via the trigger signal 204 to the third instrumentation device 500 that is the execution subject of the command. The setting value of this field is outputted, as the trigger signal 204 output request 2225, to the table read control unit 2210.

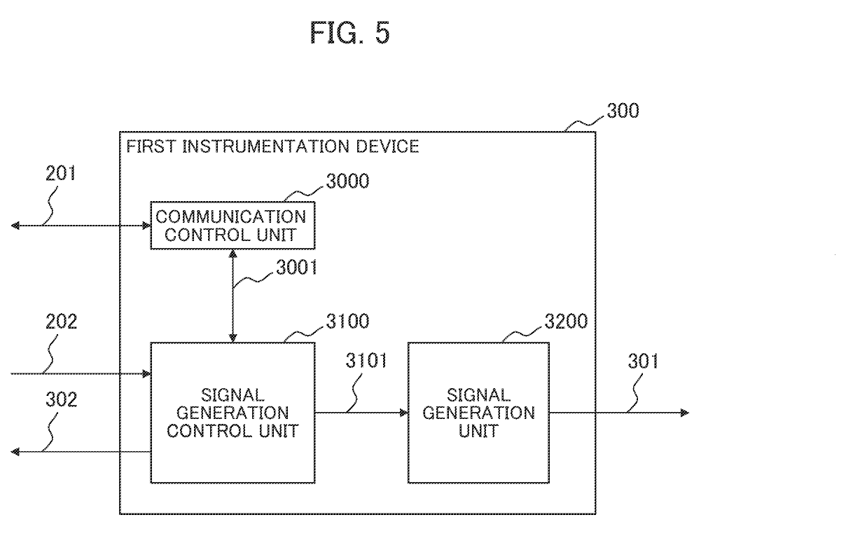

Next, the first instrumentation device 300 will be described with reference to FIG. 5. FIG. 5 is a block diagram illustrating the detailed configuration of the first instrumentation device 300. This device includes a communication control unit 3000, the signal generation control unit 3100, and the signal generation unit 3200.

The communication control unit 3000 controls the communication between the communication control unit 3000 and the sequence controller 200 connected by the communication section 201, and mutually converts various control signals between the communication control unit 3000 and an internal communication section 3001 controlling the access to the signal generation control unit 3100.

The signal generation control unit 3100 previously stores the setting information (not illustrated) defining the control output signal 301 to be outputted by the first instrumentation device 300 via the communication section 101 and the internal communication section 3001 from the host PC 100.

Although not particularly limited, the setting information may include a plurality of operations, and in that case, should further include a setting information pointer (not illustrated) as the means that can be accessed from the host PC 100 and identifies one of a plurality of pieces of setting information.

When the operation timing of the first instrumentation device 300 is instructed via the trigger signal 202, the signal generation control unit 3100 instructs the signal generation unit 3200 to switch the output state by a control signal 3101 such that the output of the control output signal 301 is brought into a state of being designated as a portion of the setting information, and notifies that the switching operation is being executed, to the sequence controller 200 by the instrumentation device operation state 302 as a signal.

When the switching is completed, the signal generation control unit 3100 notifies that to the sequence controller 200 by the instrumentation device operation state 302, and further, when the setting information pointer is present, updates (typically, increments) its content. The signal generation unit 3200 outputs the control output signal 301 to the control target device 600 in accordance with the instruction of the control signal 3101.

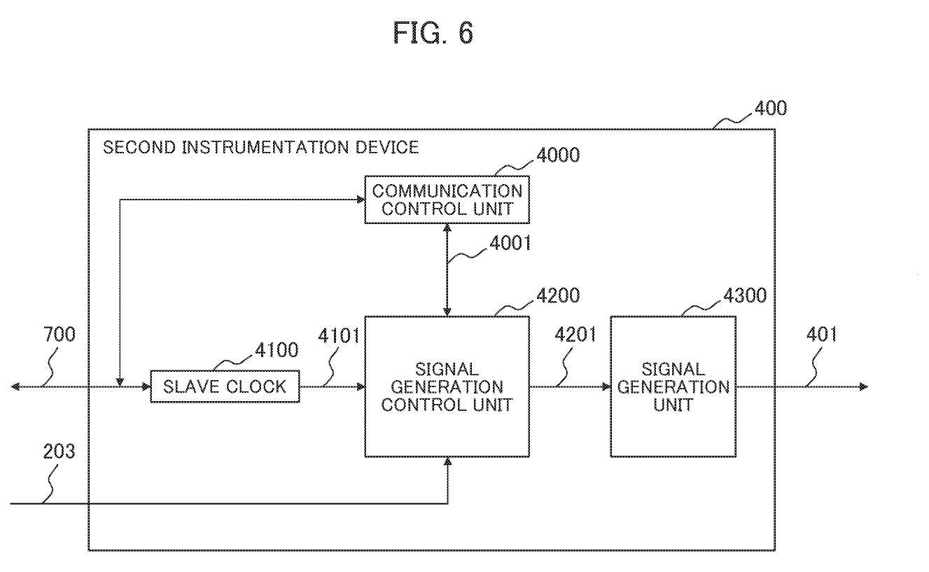

Next, the second instrumentation device 400 will be described with reference to FIG. 6. FIG. 6 is a block diagram illustrating the detailed configuration of the second instrumentation device 400. The device 400 includes a communication control unit 4000, the slave clock 4100, the signal generation control unit 4200, and the signal generation unit 4300.

The communication control unit 4000 controls the communication between the communication control unit 4000 and the host PC 100 connected by the time synchronization communication network 700 (or its alternative communication section, not illustrated), and mutually converts various control signals between the communication control unit 4000 and an internal communication section 4001 controlling the access to the signal generation control unit 4200.

The synchronization state of the slave clock 4100 and the master clock 1000 is maintained by the time synchronization communication network 700, and the slave clock 4100 typically outputs main time information 4101 inherent to this device that is the absolute time with a coarse granularity having a resolution of 1 second.

The signal generation control unit 4200 previously stores the setting information (not illustrated) defining the control output signal 401 to be outputted by the second instrumentation device 400 via the time synchronization communication network 700 (or its alternative communication section, not illustrated) from the host PC 100.

Although not particularly limited, the setting information may include a plurality of operations, and in that case, should further include a setting information pointer (not illustrated) as the means that can be accessed from the host PC 100 and identifies one of a plurality of pieces of setting information.

When detecting that the main time information 4101 indicated by the slave clock 4100 coincides with or passes the execution start time as a portion of the setting information, or when the operation timing of the second instrumentation device 400 is instructed via the trigger signal 203, the signal generation control unit 4200 instructs the signal generation unit 4300 to switch the output state by a control signal 4201 such that the output of the control output signal 401 is brought into a state of being designated as a portion of the setting information, and when the setting information pointer is present, updates (typically, increments) its content.

The signal generation unit 4300 outputs the control output signal 401 to the control target device 600 in accordance with the instruction of the control signal 4201.

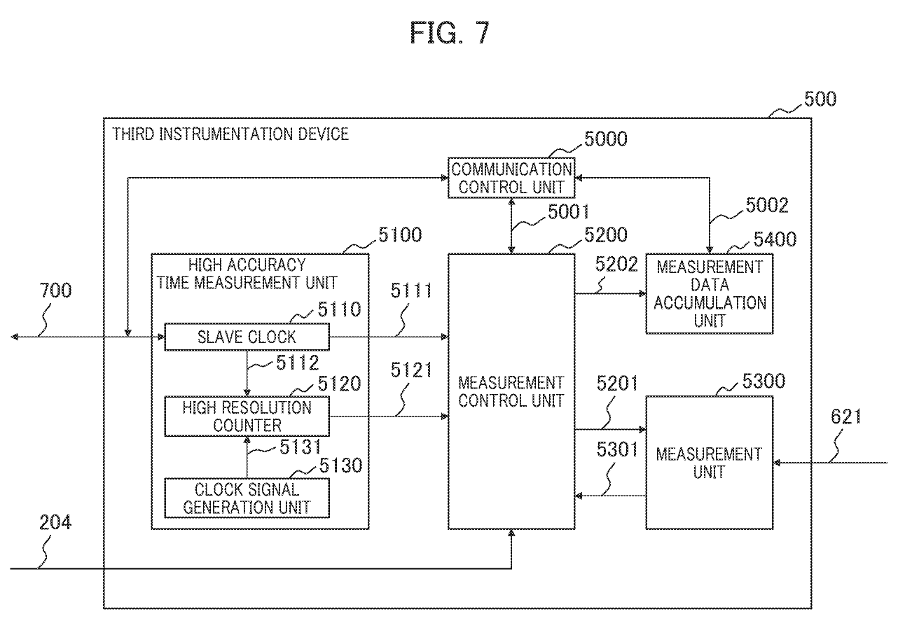

Next, the third instrumentation device 500 will be described with reference to FIG. 7. FIG. 7 is a block diagram illustrating the detailed configuration of the third instrumentation device 500. This device includes a communication control unit 5000, the measurement control unit 5200, the measurement unit 5300, the measurement data accumulation unit 5400 (data accumulation unit), and the high accuracy time measurement unit 5100 including a slave clock 5110, a high resolution counter 5120, and a clock signal generation unit 5130.

The communication control unit 5000 controls the communication between the communication control unit 5000 and the host PC 100 connected by the time synchronization communication network 700 (or its alternative communication section, not illustrated), and mutually converts various control signals between the communication control unit 5000 and an internal communication section 5001 controlling the access to the measurement control unit 5200, and between the communication control unit 5000 and an internal communication section 5002 controlling the access to the measurement data accumulation unit 5400.

Since the configuration and the operation of the high accuracy time measurement unit 5100 are shared with the high accuracy time measurement unit 2100, the detailed description thereof is omitted. The slave clock 2110 should be replaced with the slave clock 5110, the main time information 2111 should be replaced with main time information 5111, the reference signal 2112 should be replaced with a reference signal 5112, the clock signal generation unit 2130 should be replaced with the clock signal generation unit 5130, the clock signal 2131 should be replaced with a clock signal 5131, the high resolution counter 2120 should be replaced with the high resolution counter 5120, and the sub-time information 2121 should be replaced with sub-time information 5121.

The measurement control unit 5200 previously stores the setting information (not illustrated) including various parameters defining the measurement operation conditions of the third instrumentation device 500 via the time synchronization communication network 700 (or its alternative communication section, not illustrated) from the host PC 100.

Although not particularly limited, the setting information may include a plurality of measurement operations, and in that case, should further include a setting information pointer (not illustrated) as the means that can be accessed from the host PC 100 and identifies one of a plurality of pieces of setting information.

When detecting that the main time information 5111 and the sub-time information 5121 indicated by the high accuracy time measurement unit 5100 coincides with or passes the measurement start time as a portion of the setting information, or when the operation timing of the third instrumentation device 500 is instructed via the trigger signal 204, the measurement control unit 5200 instructs the measurement unit 5300 to execute the measurement operation based on the setting information by a control signal 5201, and when the setting information pointer is present, updates (typically, increments) its content.

The measurement unit 5300 measures the result signal 621 outputted by the control target device 600 in accordance with the instruction of the control signal 5201, and outputs, as measurement data 5301, the result to the measurement control unit 5200.

The measurement control unit 5200 that receives the measurement data 5301 acquires, as the measurement times of the measurement data, the contents of the main time information 5111 and the sub-time information 5121 at the point of time of reception, generates time stamp-given measurement data associated with the measurement data 5301, and requests the accumulation of the time stamp-given measurement data to the measurement data accumulation unit 5400 by a measurement data write request 5202.

The measurement data accumulation unit 5400 that receives the measurement data write request 5202 acquires the time stamp-given measurement data from the request, and writes the time stamp-given measurement data to the incorporated storage device in the predetermined format that can be read from the host PC 100.

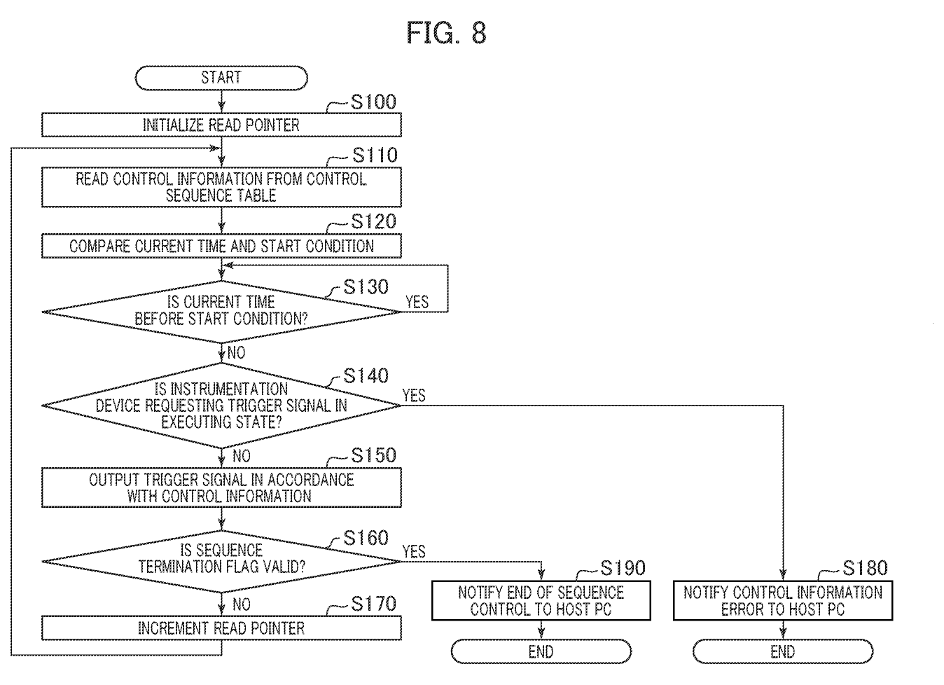

Next, the table read control unit 2210 will be described with reference to FIG. 8. FIG. 8 is a flowchart illustrating the operation of the table read control unit 2210 corresponding to the main body of the sequence control in the instrumentation system 1. However, the control information defining the control sequence and the initial value of the read pointer, that is, the information identifying the entry storing the command to be executed first in the defined control sequence, are previously set to the table read control unit 2210.

When the start of the sequence control is instructed from the host PC 100 by the predetermined means, for example, the write of the particular value to the inside control register, the table read control unit 2210 first initializes the read pointer to the designated initial value in step S100.

Subsequently, in step S110, the table read control unit 2210 reads, from the control sequence table 2220, the entry indicated by the read pointer, that is, the control information of the execution waiting command to be processed next (the command start condition, the sequence termination flag, the trigger signal 202 output request, the trigger signal 203 output request, and the trigger signal 204 output request).

In step S120, the table read control unit 2210 compares, among the control information read in step S110, the execution start time designated as the command start condition and the current time indicated by the main time information 2111 and the sub-time information 2121, and judges the before-after relationship thereof (step S130). The table read control unit 2210 waits in spin state while the current time is before the execution start time (the YES route in step S130), and waits for time to pass.

When the current time coincides with the execution start time or passes the execution start time (the NO route in step S130), in step S130, the table read control unit 2210 confirms, by the instrumentation device operation state 302, whether or not the first instrumentation device 300 is executing the preceding command.

When the first instrumentation device 300 is executing the preceding command (the YES route in step S130), this means that the necessary time interval is not set between the command that instructs the operation start and the preceding command, so that the table read control unit 2210 notifies the control information error to the host PC 100 in step S180, and ends the sequence control.

When the first instrumentation device 300 is not executing the preceding command (the NO route in step S140), in step S150, the table read control unit 2210 outputs only the trigger signal set to “valid” among the trigger signal 202 output request 2223, the trigger signal 203 output request 2224, and the trigger signal 204 output request 2225 read in step S110, and instructs the operation start of each instrumentation device necessary for the command execution.

Subsequently, in step S160, the table read control unit 2210 refers to the sequence termination flag read in step S110, and confirms whether or not the command that instructs the operation start in step S150 is the final command of the control sequence to be executed.

When the command that instructs the operation start is the final command (the YES route in step S160), the table read control unit 2210 notifies the end of the sequence control to the host PC 100 in step S190, and ends the sequence control.

When the command that instructs the operation start is not the final command (the NO route in step S160), the table read control unit 2210 increments the read pointer (step S170), and repeats the process after step S110 regarding the subsequent command.

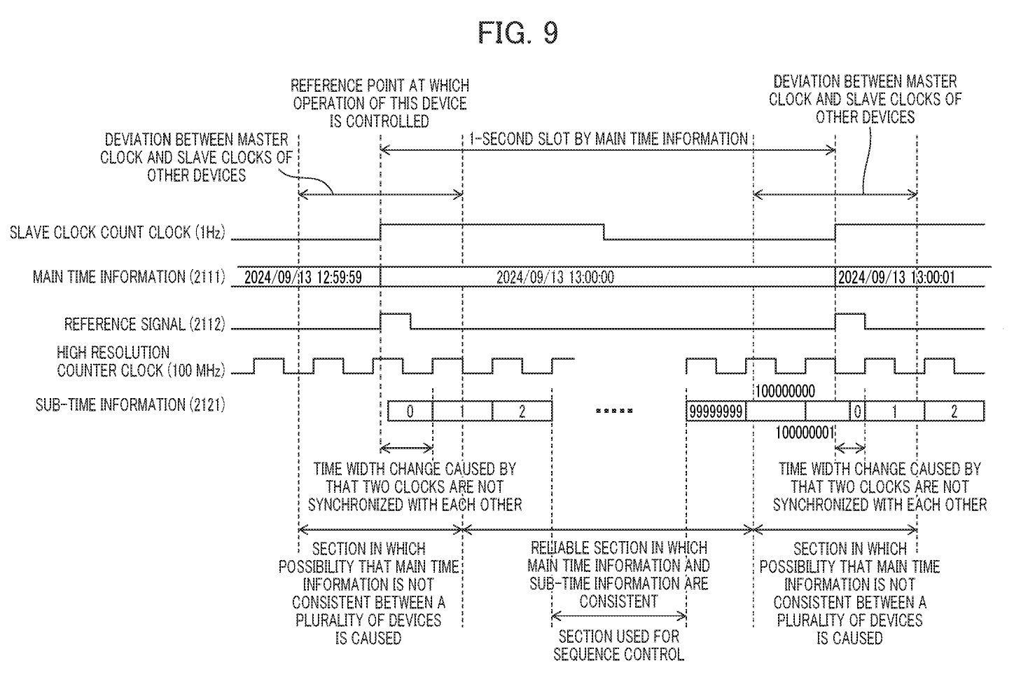

Next, the operation principle will be described with reference to FIG. 9. FIG. 9 is a timing chart explaining the main sequence control according to the first embodiment. Specifically, as illustrated in FIG. 9, the main time information 2111 marks a 1-second interval (1-second slot) in synchronization with the slave clock count clock (first clock signal) that is a reference clock of 1 Hz generated by the slave clock 2110, and further, the reference signal is also outputted at the timing of the 1-second interval. This synchronization timing becomes a reference point controlling the operation of the sequence controller 200.

In the quantum computer, fine control is required. As an example, the control is required to be performed with the time resolution of the high resolution counter clock (second clock signal) of 100 MHz generated by the high resolution counter 2120. In particular, the request in which for example, which computation in that time is performed, and the computation result is managed by being associated with the time information is required to be satisfied.

The sub-time information 2121 is outputted with the time width change caused by that the high resolution counter clock and the slave clock count clock are not synchronized with each other. Specifically, the reference signal is inputted after the rise of the high resolution counter clock, and then, after the input timing, the sub-time information 2121 is sequentially outputted in synchronization with the rise of the high resolution counter clock during the 1-second slot by the corresponding main time information. Then, the output control of the sub-time information 2121 during the 1-second slot by the next main time information is performed at the input timing of the next reference signal.

In this way, at the input timing of the reference signal, the section in which the possibility that the main time information and the sub-time information are not consistent between the devices in the sequence controller 200 is caused is formed. This corresponds to the same deviation as the master time and the slave clocks of other devices. Even when such the deviation is caused, in the first embodiment, the reliable section in which the main time information and the sub-time information are consistent during the 1-second slot is formed, and that section is a section used for the sequence control.

That is, the time reliability in the sequence controller is obtained. In addition, the minus side of the deviation of the high resolution counter clock is intended to be zero because although an output having a frequency less than the design value (100 MHz) is not provided even in consideration of the variation in manufacture and the change in environment such as temperature, it is guaranteed that up to the maximum value (100,000,000-1) is fully counted before the next reference signal reaches. Here, the incrementation is continuously performed also after the maximum value such that the main time information and the sub-time information are unique.

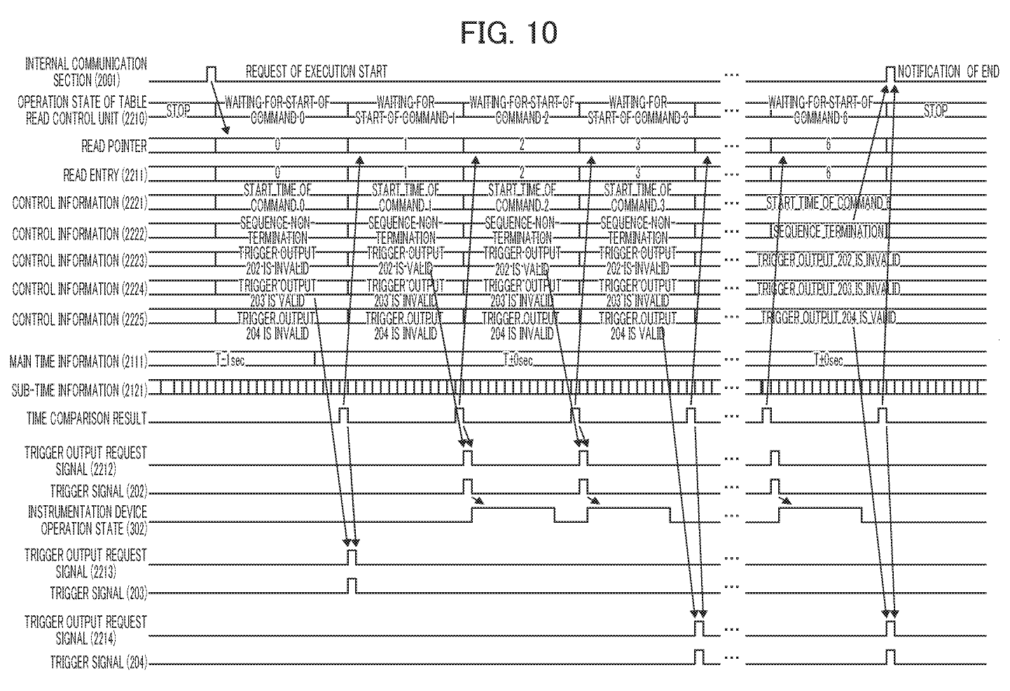

Next, the sequence control will be schematically described with reference to FIG. 10. FIG. 10 is a timing chart schematically illustrating the flow of the process of the sequence control based on the setting example of the control sequence table 2220 described in FIG. 4 in the instrumentation system 1 according to the first embodiment.

The entire control sequence includes 7 commands, and various settings necessary for the operation are appropriately initially set by the system control application operated on the host PC 100 to the sequence controller 200, the first instrumentation device 300, the second instrumentation device 400, and the third instrumentation device 500.

When the initial setting is completed, the host PC 100 requests the execution start of the sequence control process to the table read control unit 2210 via the communication section 101 and the internal communication section 2001.

The table read control unit 2210 that receives the instruction initializes the content of the read pointer to the designated value, that is, the value indicating the head entry of the control sequence table 2220, and reads the control information of the entry (the command start condition 2221, the sequence termination flag 2222, the trigger signal 202 output request 2223, the trigger signal 203 output request 2224, and the trigger signal 204 output request 2225) from the control sequence table 2220 via the read entry 2211.

At the timing at which the time comparison result between the current time indicated by the main time information 2111 and the sub-time information 2121 and the execution start time indicated by the command start condition 2221 is changed to the predetermined value indicating that the current time coincides with the execution start time or passes the execution start time, the table read control unit 2210 instructs the delay correction unit 2230 to output the trigger signal 202 by the trigger signal output request signal 2213 in accordance with the trigger signal 202 output request 2223 in which the trigger signal request is designated as “valid”, and increments the read pointer at the same time.

By repeating the above procedure until the value of the read pointer is 6, the trigger signal requesting the operation is sequentially outputted only to the instrumentation device in which the trigger signal request is designated as “valid” at the execution start time designated for each command, so that the event driven sequence control based on the trigger signal can be achieved.

For the entry 6 of the control sequence table 2220, the “valid” meaning the final command of the control sequence is read as the value of the sequence termination flag 2222. With this, according to the start of the final command, the end of the sequence control is notified to the host PC 100.

By performing the previously set predetermined operation, the instrumentation device that receives the trigger signal executes the process based on the desired control sequence for the entire instrumentation system 1. It should be noted that the instrumentation device operation state 302 that indicates the operation state of the first instrumentation device 300 is changed from the “non-operating” state to the “executing” state by the execution request from the trigger signal 202, and after the completion of the predetermined operation, is changed to the “non-operating” state again.

According to the first embodiment that has been described above in detail with reference to the drawings, regarding the sequence control of the instrumentation system built by combining a plurality of instrumentation devices, exemplified by the quantum computer, the control means that satisfies, at the same time, the high time resolution and the wide time scale that are the requests for achieving the desired performance (fidelity) is provided.

In addition, by performing the sequence control on the basis of the absolute time synchronized between the instrumentation devices, the time information having a high accuracy can be added to the measurement data acquired as a portion of the sequence execution.

With this, the manageability and traceability in the system operation can be improved, and the flexible response to various computation algorithms such as the error correction using non-real time postprocessing can also be expected, so that the practicality of the instrumentation system can be improved.

### Example 2

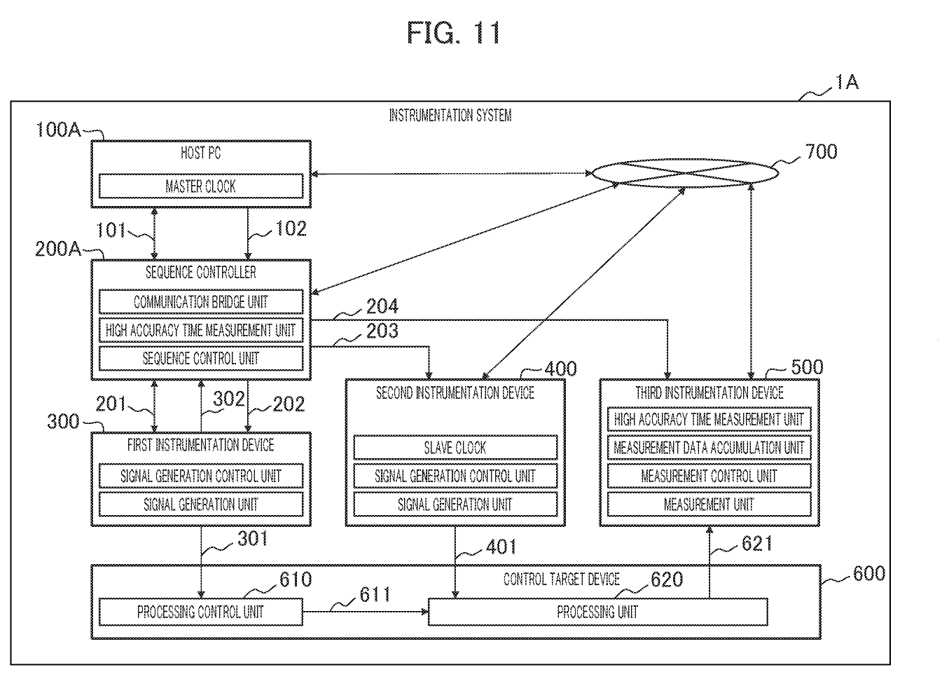

Next, an instrumentation system 1A according to a second embodiment will be described with reference to FIG. 11. Since the system configuration of the second embodiment is substantially the same as the first embodiment, the overlapped description thereof is omitted.

The configuration of the instrumentation system 1A compared with the configuration of the instrumentation system 1 (see FIG. 1) is different in the following point. That is, a reference signal 102 is added between a host PC 100A and a sequence controller 200A replacing the host PC 100 and the sequence controller 200, respectively.

The reference signal 102 is a signal indicating the change point of the time information outputted by the master clock 1000 incorporated in the host PC 100A, as the basis for the time synchronization in this system, and fundamentally has the same role as the reference signal 2112 (see FIG. 2).

It should be noted that although not particularly limited, the reference signal 102, which is connected to the sequence controller 200A, may be connected also to the instrumentation device including the high accuracy time measurement unit.

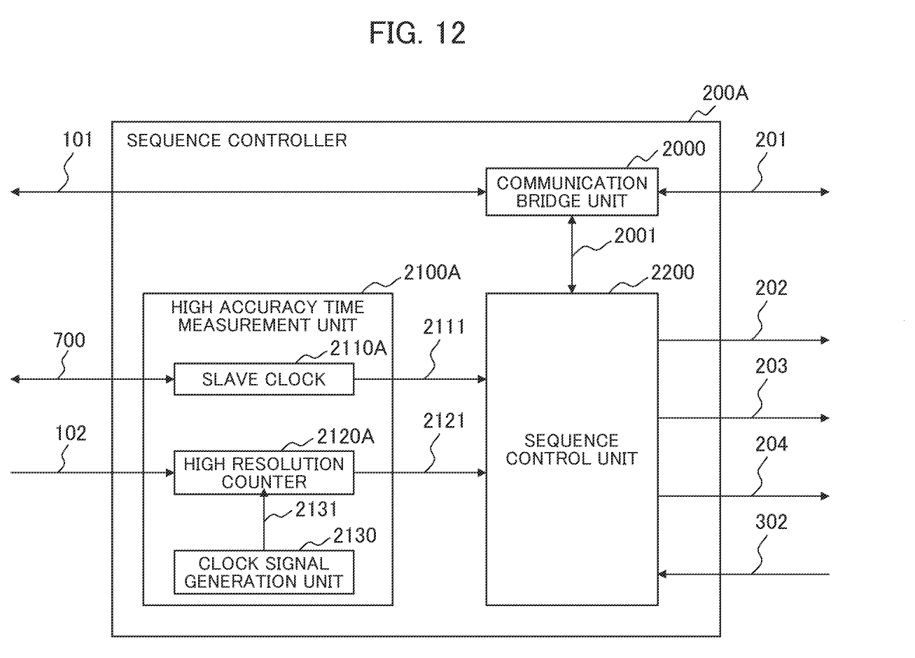

Next, the sequence controller 200A will be described with reference to FIG. 12. FIG. 12 is a block diagram illustrating the detailed configuration of the sequence controller 200A. Since the configuration of the sequence controller 200A is substantially the same as the configuration of the sequence controller 200, the overlapped description thereof is omitted.

The configuration of the sequence controller 200A compared with the configuration of the sequence controller 200 (see FIG. 2) is different in the following point. That is, a high accuracy time measurement unit 2100A adds the reference signal 102 to the high accuracy time measurement unit 2100, replaces the slave clock 2110 with a slave clock 2110A deleting the reference signal output, and replaces the high resolution counter 2120 with a high resolution counter 2120A in which the connection destination of the reference signal is changed from the reference signal 2112 to the reference signal 102. The reference signal 2112 is deleted.

In the second embodiment, when the wiring delay of the reference signal 102 is smaller than the jitter achieved by the time synchronization communication network 700, the sequence control and the accuracy (coincidence properties) of the operation timings of the respective instrumentation devices can be improved.

It should be noted that the jitter is left between the slave clock 2110A and the high resolution counter 2120A, but the absolute time during the constant period after the initialization of the high resolution counter 2120A by the reference signal 102 and before the next initialization (for example, the time that is approximately twice the jitter) is not designated as the command start condition, so that the influence can be avoided.

### Example 3

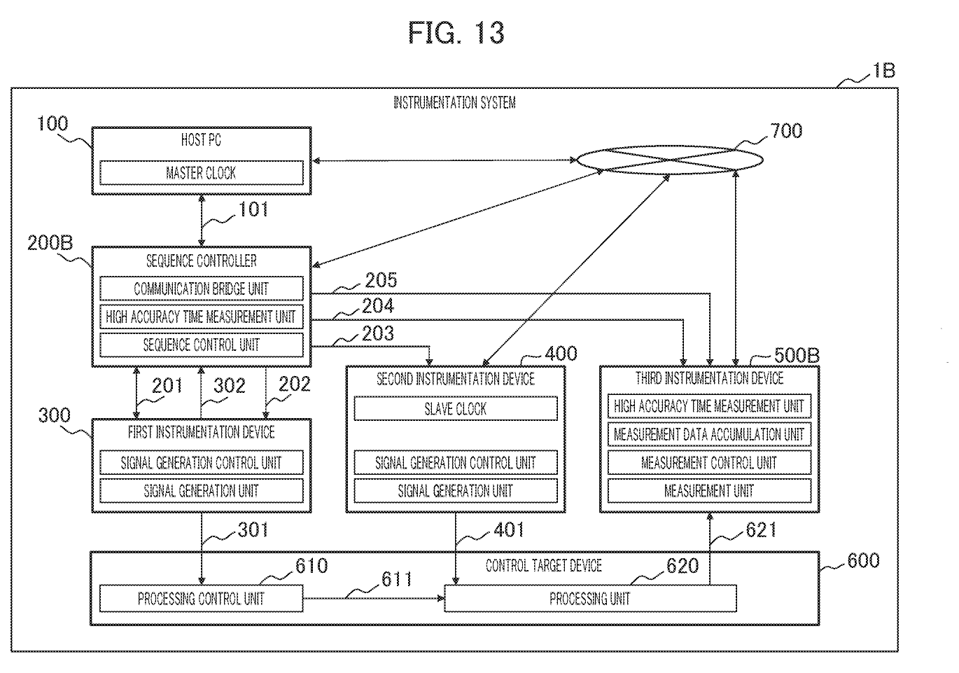

Next, an instrumentation system 1B according to a third embodiment will be described with reference to FIG. 13. Since the system configuration of the third embodiment is substantially the same as the first and the second embodiments, the overlapped description thereof is omitted.

The configuration of the instrumentation system 1B compared with the configuration of the instrumentation system 1 (see FIG. 1) is different in the following point. That is, a reference signal 205 is added between a sequence controller 200B and a third instrumentation device 500B replacing the sequence controller 200 and the third instrumentation device 500, respectively. The reference signal 205 is a signal equivalent to the reference signal 2112 (see FIG. 2) as the internal signal of the sequence controller 200.

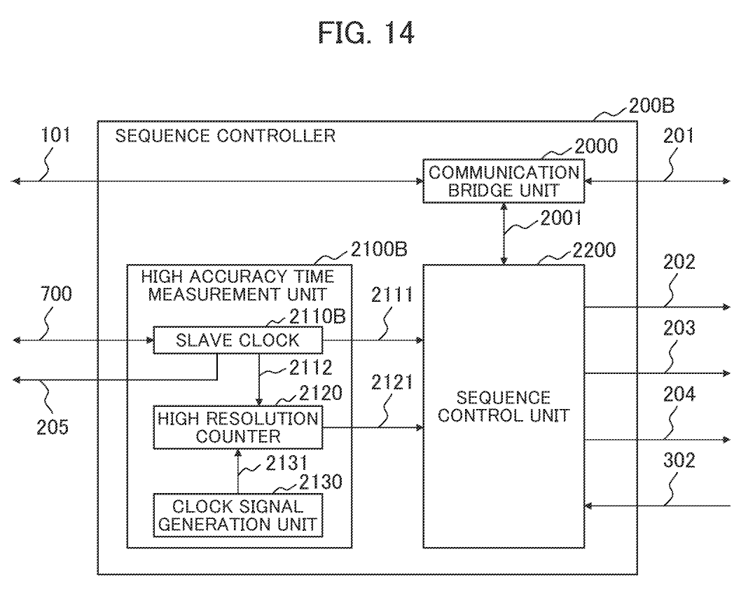

Next, the sequence controller 200B will be described with reference to FIG. 14. FIG. 14 is a block diagram illustrating the detailed configuration of the sequence controller 200B. Since the configuration of the sequence controller 200B is substantially the same as the configuration of the sequence controller 200, the overlapped description thereof is omitted.

The configuration of the sequence controller 200B compared with the configuration of the sequence controller 200 (see FIG. 2) is different in the following point. That is, a high accuracy time measurement unit 2100B adds the reference signal 205 to the high accuracy time measurement unit 2100, and replaces the slave clock 2110 with a slave clock 2110B to which the reference signal 205 is added.

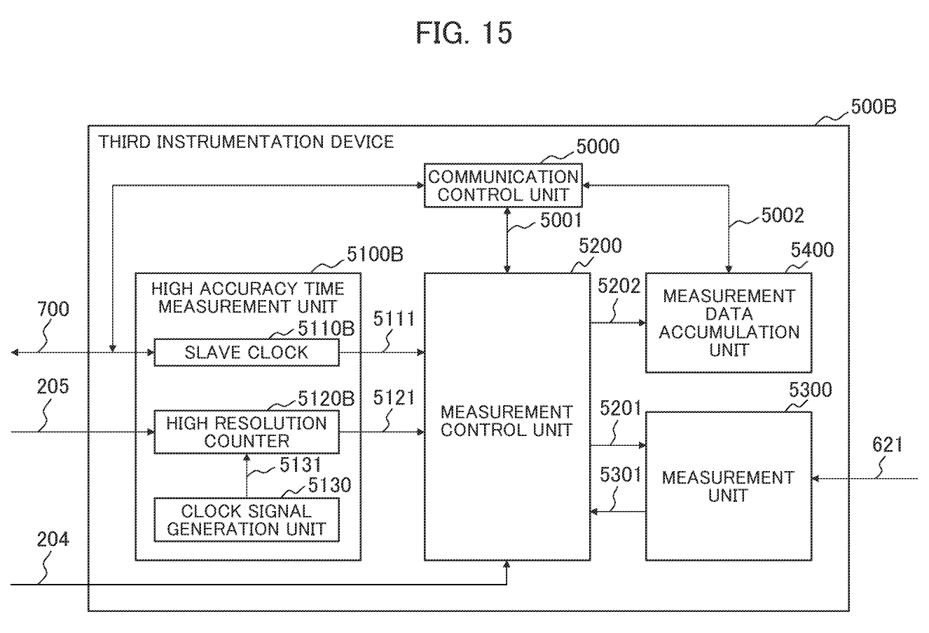

Next, the third instrumentation device 500B will be described with reference to FIG. 15. FIG. 15 is a block diagram illustrating the detailed configuration of the third instrumentation device 500B. Since the configuration of the third instrumentation device 500B is substantially the same as the configuration of the third instrumentation device 500, the overlapped description thereof is omitted.

The configuration of the third instrumentation device 500B compared with the configuration of the third instrumentation device 500 (see FIG. 7) is different in the following point. That is, a high accuracy time measurement unit 5100B adds the reference signal 205 to the high accuracy time measurement unit 5100, replaces the slave clock 5110 with a slave clock 5110B deleting the reference signal output, and replaces the high resolution counter 5120 with a high resolution counter 5120B in which the connection destination of the reference signal is changed from the reference signal 5112 to the reference signal 205. The reference signal 5112 is deleted.

According to the third embodiment, even the high accuracy time measurement unit 5100B incorporating the slave clock 5110B not having the reference signal output function can generate the absolute time having a high resolution in combination with the reference signal 205 from another device for use.

It should be noted that the jitter is left between a slave clock 5110B and the high resolution counter 5120B, but the absolute time during the constant period after the initialization of the high resolution counter 5120B by the reference signal 205 and before the next initialization (for example, the time that is approximately twice the jitter) is not designated as the command start condition, so that the influence can be avoided.

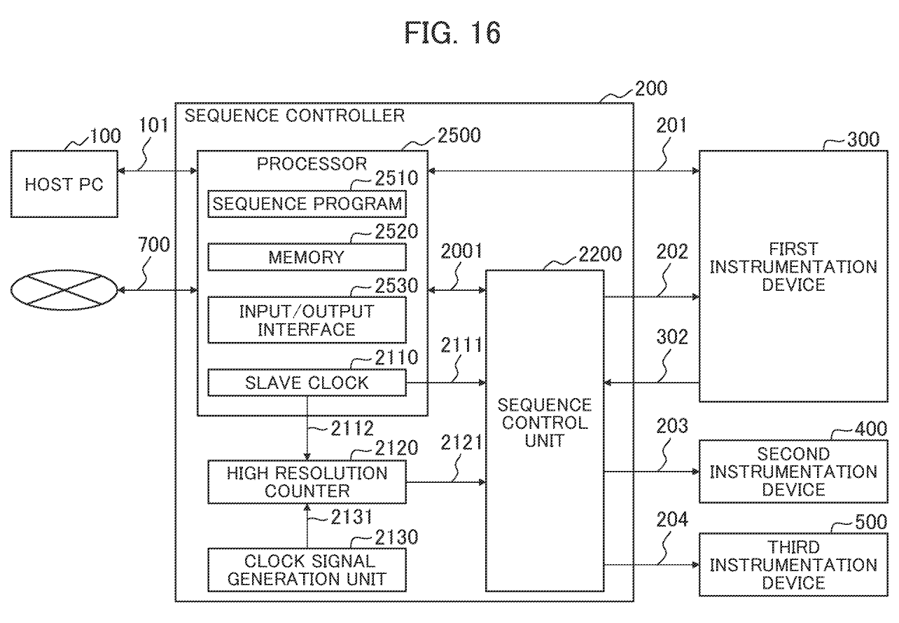

Next, the hardware configuration will be described with reference to FIG. 16. FIG. 16 is a configuration diagram illustrating the hardware configuration example of the sequence controller shared between the respective embodiments. By taking the first embodiment described above as an example, the sequence controller 200 includes a processor 2500.

The processor 2500 includes a sequence program 2510, a memory 2520, an input/output interface 2530, and the slave clock 2110, and governs, in the sequence controller according to the first embodiment described above, the function of the communication bridge unit 2000, the communication between the processor 2500 and the time synchronization communication network 700, and the management of the slave clock 2110.

Also for the second and the third embodiments, the same configuration as the hardware configuration according to the first embodiment described above is applied, and as already described, the different point is in the function implementation arrangement.

The embodiments of the present invention have been described above, but these embodiments are exemplified as examples, and are not intended to limit the scope of the invention. These novel embodiments can be performed in other various forms, and various omissions, replacements, and changes can be made in the scope not departing from the purport of the invention.

These embodiments and their modifications are included in the scope and the purport of the invention, and are included in the invention described in the scope of claims and the scope equivalent thereto. The components described in the embodiments may be achieved by dedicatedly designed hardware like, for example, ASIC (Application Specific Integrated Circuit), and may be achieved by programmable hardware like FPGA (Field-Programmable Gate Array). In addition, the software operated on the host PC may serve as at least some functions.

According to the above examples, the practical quantum computer can be achieved, so that the consumption energy is less, the amount of carbon emissions can be reduced, and the global warming can be prevented, thereby contributing to the achievement of the sustainable society.

What is claimed is:

1. A sequence controller that is connected to one or more instrumentation devices comprising:
a first time measurement device outputting main time information having a first time resolution on the basis of a first clock signal;
a second time measurement device outputting sub-time information having a second time resolution higher than the first time resolution on the basis of each timing of a second clock signal different from the first clock signal and a reference signal outputted by the first time measurement device; and
a sequence control unit generating and outputting a trigger signal instructing an operation timing to each of the one or more instrumentation devices on the basis of the main time information and the sub-time information.

2. The sequence controller according to claim 1, wherein
the second clock signal allows an error with respect to a frequency design value that is not zero in the positive direction and is zero in the negative direction.

3. The sequence controller according to claim 1, wherein
the second time measurement device is initialized for each set of N-time (provided that N is the number of the divisor of 60) reference signal receptions.

4. The sequence controller according to claim 1, wherein
the sequence controller includes a control sequence table, and a table read control unit, the control sequence table holds an operation start time indicating the operation timing of at least one of the one or more instrumentation devices, and a setting value identifying each of the one or more instrumentation devices to instruct operation start at the time, and the table read control unit outputs the trigger signal to each of the one or more instrumentation devices on the basis of the main time information, the sub-time information, and the setting value of the sequence table.

5. The sequence controller according to claim 4, wherein
the table read control unit receives, from at least one of the one or more instrumentation devices, information identifying the operation state of the instrumentation device.

6. The sequence controller according to claim 5, wherein
the table read control unit detects the instruction of new operation start with respect to the instrumentation device in which the information identifying the operation state indicates that the instrumentation device is operating.

7. The sequence controller according to claim 1, wherein
the sequence controller includes a delay correction unit adding the delay of an inherent time to the trigger signal outputted to each of the one or more instrumentation devices.

8. An instrumentation system comprising: one or more instrumentation devices;
a first time measurement device outputting main time information having a first time resolution on the basis of a first clock signal;
a second time measurement device outputting sub-time information having a second time resolution higher than the first time resolution on the basis of each timing of a second clock signal different from the first clock signal and a reference signal outputted by the first time measurement device; and
a sequence control unit generating and outputting a trigger signal instructing an operation timing to each of the one or more instrumentation devices on the basis of the main time information and the sub-time information.

9. The instrumentation system according to claim 8, wherein
a sequence controller having the second time measurement device and the sequence control unit is configured, and the reference signal is an interface signal between the inside and the outside of the sequence controller.

10. The instrumentation system according to claim 8, wherein
a sequence controller having the first time measurement device and the sequence control unit is configured, the second time measurement device is implemented outside the sequence controller, and the reference signal is an interface signal between the inside of the sequence controller and the second time measurement device.

11. An instrumentation system according to claim 8, wherein
at least one of the one or more instrumentation devices includes
the first time measurement device;
the second time measurement device;
a measurement unit measuring a control signal based on the main time information and the sub-time information to output measurement data; and
a data accumulation unit storing data in a predetermined form in which the main time information, the sub-time information, and the measurement data are associated with each other.

12. A sequence control method of an instrumentation system, wherein
in accordance with a request from each of one or more time measurement devices, a trigger signal is generated with respect to the each time measurement device making the request according to a previously prepared sequence operation order by using main time information and sub-time information made to have a higher resolution than the main time information, and the generated respective trigger signals are synchronized with each other to sequence control the respective time measurement devices.
